(19) United States
(12) Patent Application Publication
(10) Pub. No.: US 2023/0129583 A1
(43) Pub. Date: Apr. 27, 2023

(54) TORQUE REDUCING FLOW DRILLING FASTENER FOR THICK MATERIALS AND METHOD OF USING SUCH FASTENER

(71) Applicant: Semblex Corporation, Elmhurst, IL (US)

(72) Inventors: Brandt J. Ruszkiewicz, Glendale Heights, IL (US); Eric C. Breidenbaugh, Elmhurst, IL (US); Gene M. Simpson, Algonquin, IL (US)

(21) Appl. No.: 17/975,239

(22) Filed: Oct. 27, 2022

Related U.S. Application Data
(60) Provisional application No. 63/272,482, filed on Oct. 27, 2021.

(51) Int. Cl. F16B 25/10; F16B 25/00

(52) U.S. Cl. CPC F16B 25/106; F16B 25/0021

(57) ABSTRACT

A self-penetrating thread forming and flow drilling fastener for thick materials with a generally cylindrical partially threaded shank, a drive system at the first end of the shank and a flow drilling tip at the second end of the shank. The flow drilling tip is sized larger than the minor diameter of the threaded shank but less than the major diameter to control installation torque enabling installation into thick materials with greatly reduced risk of torsional failure resultant from a decrease in torque. The flow drilling tip and threads may be a variety of shapes or thread types based on the substrate material the fastener is installed into.

The present utility application claims priority to U.S. Provisional Patent Application No. 63/272,482, which was filed on Oct. 27, 2021, which is hereby incorporated by reference in its entirety.

The present invention relates to a hole forming self-tapping flow drill screw, and to a method of using such a screw. Hole forming self-tapping screws fasten multiple materials together by using frictional heat generated by rotation and axial loading of the fastener against the substrate materials. The heat plasticizes the material allowing the fastener to penetrate through the substrates without cutting. After penetrating the substrate(s), the fastener forms threads into them and tightens down to secure them. During installation, the fastener experiences a torque as it forms threads into the substrate, known as the thread forming torque. This magnitude of this torque is proportional to the substrate material thickness and strength. If the material is too thick or too strong, the threadforming torque can exceed the torsional strength of the fastener, resulting in fastener failure.

### BACKGROUND

Multiple different types of hole forming self-tapping screws already exist for application in sheet materials, composites, and polymers (such as U.S. Pat. Nos. 9,175,708 and 5,234,301). These designs incorporate a threaded screw shank, tapering thread region, and forming tip. For example, U.S. Pat. No. 5,234,301 features a cylindrical area that joins the tapered thread region to the forming tip, this cylindrical region is of constant diameter and sized to be less than the pitch diameter of the threaded portion of the screw. This unthreaded region size constraint limits the fastener's performance in thick materials due to excess material flow into the threads during the thread forming process. In other words, the hole it creates is too small to allow for optimized material flow resulting in excessive friction forces on the fastener and a high thread forming torque. With regard to U.S. Pat. No. 9,175,708, the fastener disclosed therein does not have an unthreaded region between the forming tip and tapering threads and instead has a forming tip with a constantly reducing cross section from the tapering threads towards the terminating portion of the forming tip. The forming tip is comprised of two adjacent sections of curvature. This art does not make any claims on the sizing of the forming tip.

Another example of a hole forming connecting element is described in U.S. Pat. No. 10,508,676. This fastener uses a region of annular rings (ribs), of which each ring is disconnected from the rings that precede or follow it, a region without ribs, and a hole forming tip. The hole forming tip is larger than the un-ribbed region, but smaller than the maximum diameter of the ribs. This fastener does not utilize helical threads, and as such, it is not a screw (i.e., a threaded fastener).

A fourth hole-forming self-tapping screw, and a method of using such a fastener, is disclosed in U.S. Pat. No. 10,598,205, which is incorporated herein in its entirety. U.S. Pat. No. 10,598,205 was filed on Feb. 20,2018 as Ser. No. 15/900,507, and is assigned to the Semblex Corporation of Elmhurst, Ill. It relates to the use of multi-lead/multi-helix threads on flow drill type fasteners.

### BRIEF SUMMARY OF THE INVENTION

The present invention is based on developing proper tip sizing for self-tapping flow drilling screw with improved properties that allow it to be effectively used in thick materials and expand the current thickness range of existing flow drill fastener art.

Certain embodiments of the present invention relate to a self-tapping and flow drilling fastener with a generally cylindrical shank having a central longitudinal axis, a driver feature at the first end of the shank used to rotate and apply load the fastener, and a flow drilling (hole forming) tip at the second end of the shank. The shank has a helical thread encircling the shank from the general area of the first end towards the flow drilling tip in a helical manner. The shank may be fully or partially threaded. The fastener may or may not utilize a tapered thread region before the hole forming tip. The threaded region may consist of variety of thread geometries depending on the substrate to be flow drill fastened. The flow drilling tip has a diameter at its largest point that is greater than the smallest diameter of the helical thread feature, including tapered threads but smaller than the largest diameter of the helical thread feature. The tip may be round, polygonal, or a combination of the previous.

### BRIEF DESCRIPTION OF THE DRAWINGS

FIG. 1 is a drawing outlining the basic components of a hole forming/flow drilling self-tapping fastener;

FIG. 2 is a drawing outlining the critical dimensions which relate the flow drilling tip size of the FIG. 1 embodiment;

FIGS. 3A-3C show three potential tapered lead thread region embodiments of the invention described herein;

FIGS. 4A-4C show three cross-sections of potential embodiments of helical thread types that may be used with the proposed invention. The dashed circles for the spiral lobe and polygon cross sections show the major diameter traced by the largest diameter feature of the helical thread;

FIGS. 5A-5C show potential flow drilling tip shapes that may be combined with the flow drilling tip sizing described herein;

FIGS. 6A and 6B shows potential tip terminations;

FIG. 7 is one example of a type of drive system that may be used for inserting the present fastening device into a workpiece; and;

FIGS. 8A-8F are a series of side views showing the steps involved in one example of a method for inserting the present fastening device into a workpiece.

### DETAILED DESCRIPTION OF THE INVENTION

As mentioned above, flow drilling fasteners form a hole into their mating part, form threads into the part, and then tighten to secure two or more parts. The hole is flow drilled using the flow drilling tip of the screw, which is rotated at high rpm and pushed against the mating materials, resulting in heat generation and the formation of a flow formed hole. The size of the resulting hole is equal to the diameter of the tip of the screw at its largest point. The fastener then forms threads into this hole using its tapered region, creating material flow that fills in the threads of the fastener. One example of the details of a flow drilling fastener, and a method of using such a fastener, is disclosed in U.S. Pat. No. 10,598,205.

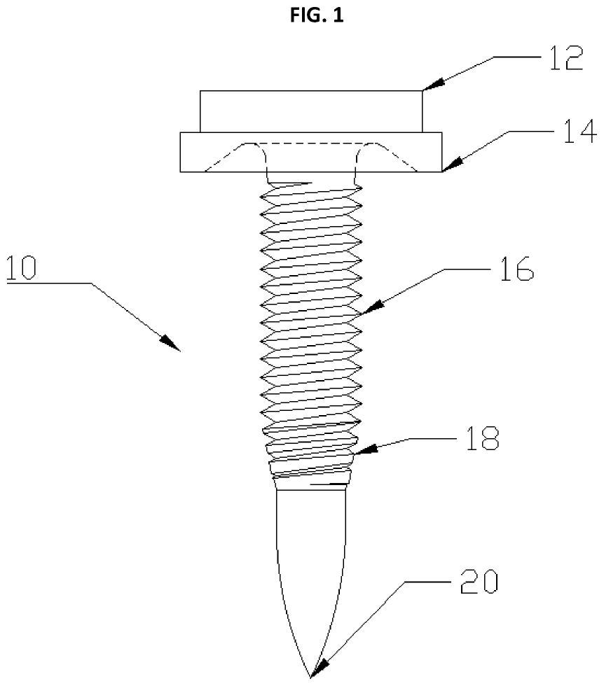

Turning now to FIGS. 1-8F, various examples of features of the present fastening device are shown and will be described. FIG. 1 shows a side view of an example of a fastening device (or fastener) 10 of the present invention that includes a drive arrangement (or system) 12, a head region 14, a full-size threaded region 16, a tapered threaded region 18, and a flow drilling tip 20 portion. The fastener 10 of the present invention may be made of any suitable material, such as any of the following metals: (i) low and medium carbon steels; (ii) medium carbon alloy steels; (iii) stainless steels; (iv) high carbon steels; (v) high carbon alloy steels; and (vi) aluminum alloys.

The drive arrangement 12 and the head region 14 may be considered as part of a head portion of the fastener 10, and the threaded regions 16/18 and the flow drilling tip region 20 may be considered as part of a shank portion of the fastener 10. In the referred embodiments, the threads of the threaded regions(s) are continuous helical threads. It should be noted that the tapered threaded region 18 is optional.

It should be noted that the threads of the threaded regions 16/18 may be a single spiral or include multiple spiral feature(s) that encompass the length of the helical thread. The helical thread may be a standard thread or any commercially viable thread geometry best suited for the substrate to be fastened. Further, the helical thread may have single or multiple leads.

The drive arrangement 12 is configured and arranged for receiving a rotary driving force to drive the fastening device 10 into a single workpiece, or into a plurality of superposed workpieces. It is contemplated that the drive arrangement may be any type of conventionally known drive arrangement (either an internal drive arrangement, such as slotted, Phillips, Torx, square, hex, socket, etc. or an external drive arrangement, such as hex, 12-point, line head, Torx, Torx Plus, etc.).

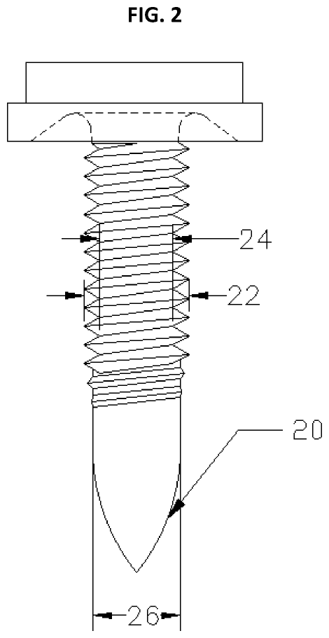

Turning now to FIG. 2, the critical dimensional relationships of the fastener 10 of FIG. 1 will be described. FIG. 2 shows how the full-size threaded region 16 defines a major diameter 22 and a minor diameter 24. The major diameter 22 is defined as the diameter of an imaginary co-axial cylinder that just touches the crest of the largest thread of an external thread as shown in FIG. 2 (or the root of an internal thread), and the minor diameter 24 is the diameter of an imaginary cylinder that just touches the roots of the largest thread of an external thread as also shown in FIG. 2 (or the crests of an internal thread). Thus, in the embodiment of FIGS. 1 and 2, which includes the full-size threaded region 16 and the tapered threaded region 18, the major and minor diameters are measured in the full-size threaded region 16, because this region includes the largest diameter thread. However, the present invention is not limited to embodiments that include a full-size threaded region and a tapered threaded region. Instead, for example, the tapered threaded region may be omitted (resulting in a single threaded region of uniform diameter), and thus the major and minor diameters are measured in the single threaded region. Other embodiments that include a plurality of threaded regions of different diameters (either uniform or tapered) are also contemplated, and in such situations, the major diameter will still be defined the diameter of an imaginary co-axial cylinder that just touches the crest of whatever thread is the largest thread, and the minor diameter will still be defined as the diameter of an imaginary cylinder that just touches the roots of whatever thread is the largest thread.

FIG. 2 also shows how the flow drilling tip region 20 defines a tip diameter 26. The larger the tip diameter, the greater reduction in torque experienced by the screw allowing the fastener to flow drill and form threads into thicker substrates without risk of torsional failure.

In the present invention, it is critical that the tip diameter (T_{D}) 26 is greater than the minor diameter (Dₘᵢₙₒᵣ) 24 and that the tip diameter (T_{D}) 26 is also less than or equal to the major diameter (Dₘₐⱼₒᵣ) 22. In other words, the present invention satisfies the following equations: (i) T_{D}>Dₘᵢₙₒᵣ and (ii) T_{D}≤Dₘₐⱼₒᵣ. Preferably, the tip diameter (T_{D}) 26 is greater than or equal to 1.02 times the minor diameter (Dₘᵢₙₒᵣ) 24, while also still being less than or equal to the major diameter (Dₘₐⱼₒᵣ) 22. In other embodiments: (i) the tip diameter (T_{D}) 26 is greater than or equal to 1.1 times the minor diameter (Dₘᵢₙₒᵣ) 24, while also still being less than or equal to the major diameter (Dₘₐⱼₒᵣ) 22; or (ii) the tip diameter (T_{D}) 26 is greater than or equal to 1.2 times the minor diameter (Dₘᵢₙₒᵣ) 24, while also still being less than or equal to the major diameter (Dₘₐⱼₒᵣ) 22; or (iii) the tip diameter (T_{D}) 26 is greater than or equal to 1.25 times the minor diameter (Dₘᵢₙₒᵣ) 24, while also still being less than or equal to the major diameter (Dₘₐⱼₒᵣ) 22.

The particular configuration of the present invention, including the relative sizing of the tip diameter (T_{D}), the minor diameter (Dₘᵢₙₒᵣ), and the major diameter (Dₘₐⱼₒᵣ) mentioned above, allows the present fastener to be effectively used in thick materials, such as in a sheet of aluminum of up to a thickness of 10 mm in certain cases, which is a 4 mm increase over conventional flow drill fasteners, or in a magnesium sheet of between 4 and 8 mm. Such increased thicknesses are possible because, when the relative relationships between T_{D}, Dₘᵢₙₒᵣ, and Dₘₐⱼₒᵣ described herein are utilized, the hole created by the present flow drilling fastener is large enough to allow for optimized material flow, resulting in reduced friction forces on the fastener and a lower thread forming torque.

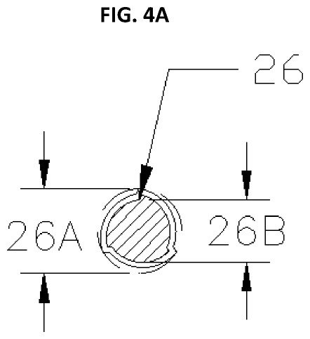

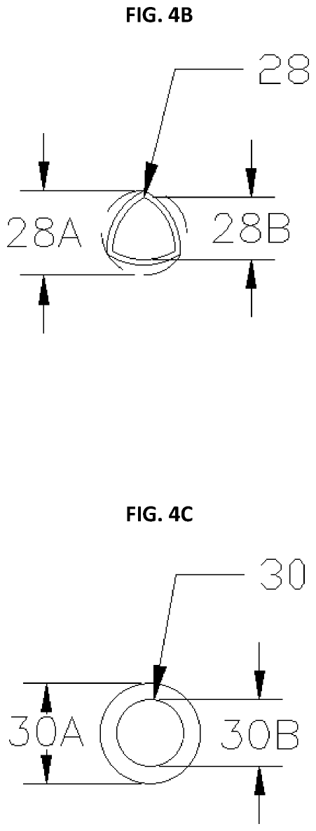

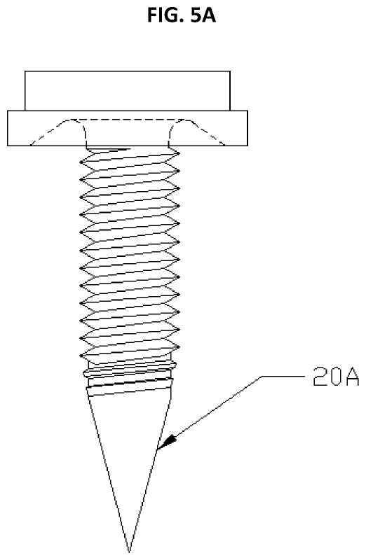

Next, various optional features and/or modifications to the embodiment of FIGS. 1 and 2 will be described while referring to FIGS. 4A-4C, FIGS. 5A-5C, and 6A-6B.

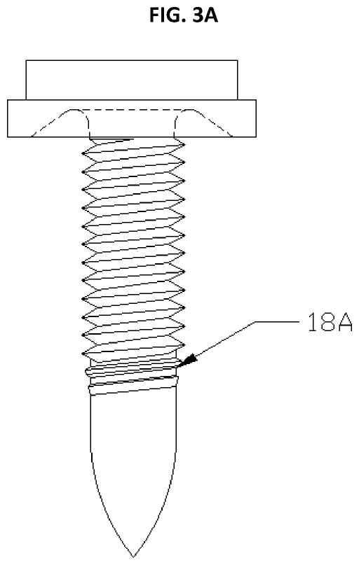

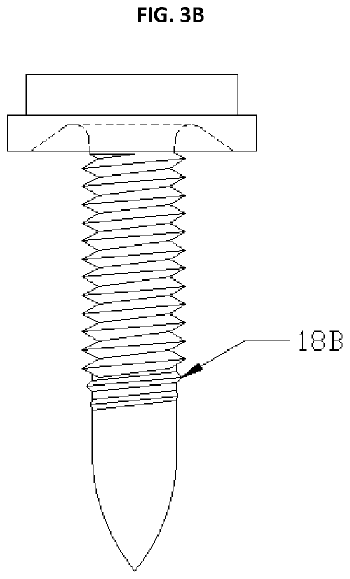

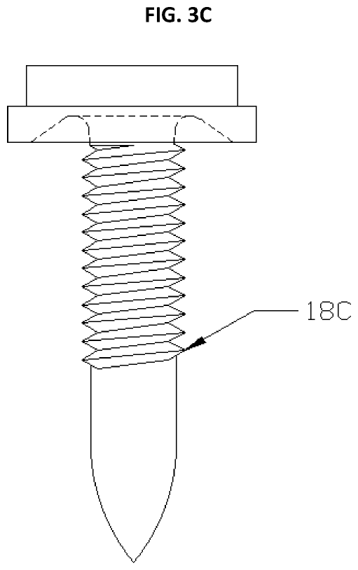

First, with regard to FIGS. 3A-3C, these figures show several variations for the profile of the threads in the tapered thread region 18 (FIG. 1), where unless otherwise noted, the other features of the fasteners of FIGS. 3A-3C are the same as those of FIGS. 1 and 2. For example, FIG. 3A shows a fastener that includes a tapered thread region 18A that includes flat-crested tapered threads. Next, FIG. 3B shows a fastener with a tapered thread region 18B that includes sharp-crested tapered threads.

Finally, FIG. 3C shows a fastener with a tapered thread region 18C that includes quarter turn tapered threads. As these thread profiles are known to those or ordinary skill in the art, further details are not necessary. Further, it is also contemplated that other thread profiles may be utilized in the present invention, as long as the disclosed relationships between T_{D}, Dₘᵢₙₒᵣ, and Dₘₐⱼₒᵣ described herein are followed.

Next, with regard to FIGS. 4A-4C, these figures show several variations for the cross-sectional shape of the fastening device 10 of FIGS. 1 and 2. Unless otherwise noted, the other features of the fasteners of FIGS. 4A-4C are the same as those of FIGS. 1 and 2. For example, FIG. 4A shows a cross-section of a shank region of a fastener that includes a spiral lobe cross-section 26, where 26A represents the major diameter and 26B represents the minor diameter of the threaded region. Next, FIG. 4B shows a cross-section of the shank region of a fastener with a polygon cross-section 28, where 28A represents the major diameter and 28B represents the minor diameter of the threaded region. Finally, FIG. 4C shows a cross-section of the shank region of a fastener with a round cross-section 30, where 30A represents the major diameter and 30B represents the minor diameter of the threaded region. As these cross-sectional shapes are known to those or ordinary skill in the art, further details are not necessary. Further, it is also contemplated that other cross-sectional shapes may be utilized in the present invention, as long as the disclosed relationships between T_{D}, Dₘᵢₙₒᵣ, and Dₘₐⱼₒᵣ described herein are followed.

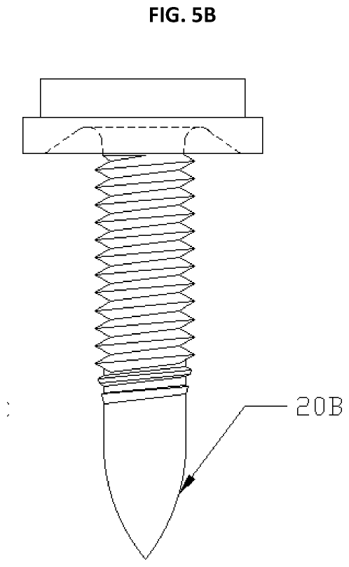

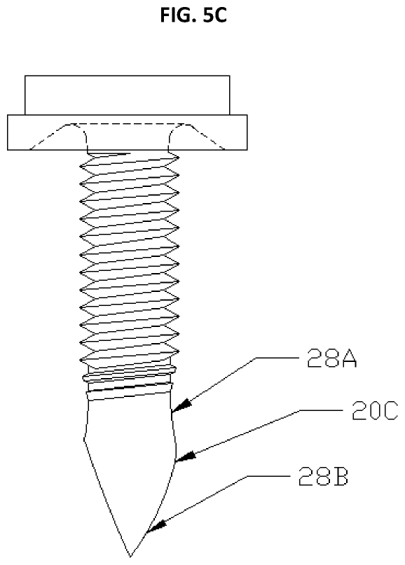

Turning now to FIGS. 5A-5C, these figures show several variations for the shape of the tip of the fastening device 10 of FIGS. 1 and 2. Unless otherwise noted, the other features of the fasteners of FIGS. 5A-5C are the same as those of FIGS. 1 and 2. FIG. 5A shows a fastener that includes a flow drilling tip region that consists of a symmetrical linear tip 20A. Next, FIG. 5B shows an example of a fastener with a single radius (or parabolic (polynomial)) symmetrical tip 20B. In certain embodiments, the radius less is than or equal to 1 mm. Finally, FIG. 5C shows a fastener with a tip 20C that is asymmetrical and that includes multiple different radiuses or parabolic sections, such a first parabolic section 28A and second parabolic section 28B. As these different tip configurations are known to those or ordinary skill in the art, further details are not necessary. Further, it is also contemplated that other tip configurations may be utilized in the present invention, as long as the disclosed relationships between T_{D}, Dₘᵢₙₒᵣ, and Dₘₐⱼₒᵣ described herein are followed.

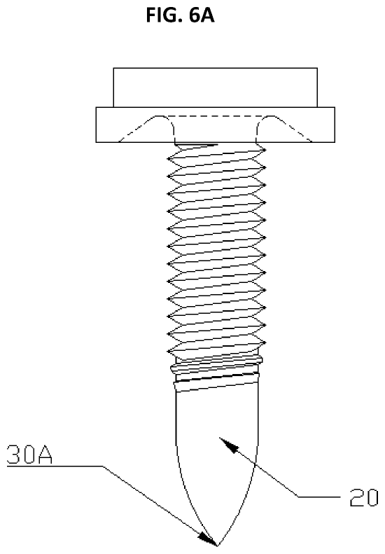

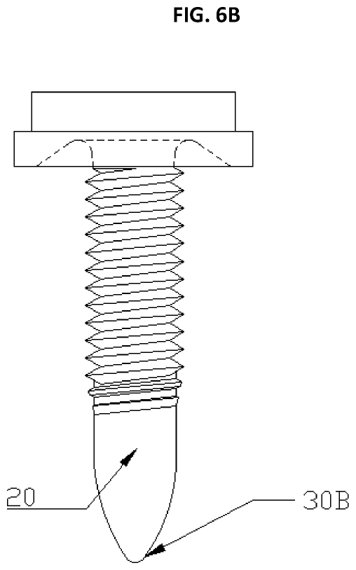

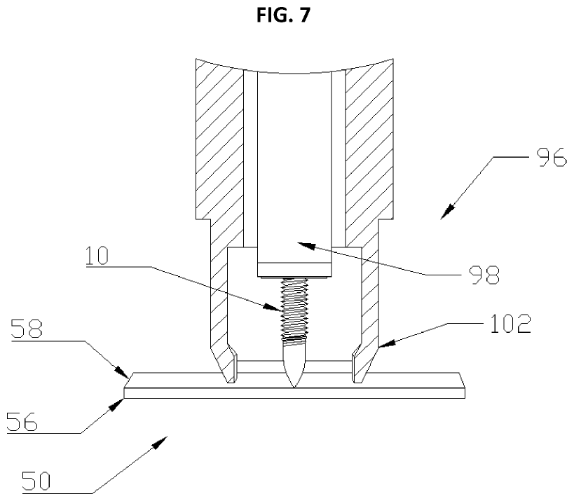

FIGS. 6A and 6B show how the point of the flow drilling tip region 20 can be of any desired configuration, such as the configuration shown in FIG. 6A, which includes a sharp point 30A, or the configuration shown in FIG. 6B, which includes a radius point 30B. As these different tip configurations are known to those or ordinary skill in the art, further details are not necessary. Further, it is also contemplated that other point configurations may be utilized in the present invention, as long as the disclosed relationships between T_{D}, Dₘᵢₙₒᵣ, and Dₘₐⱼₒᵣ described herein are followed.

This outer distal end of the tip region may be formed by any desired method, such as by using any of the following methods (alone or in combination with each other): (i) a pointing method, which can be achieved through a shaving operation, a shaped tool shaving operation, or any other cutting based process that removes material; (ii) a pinch pointing method, which is a forging based point forming process where an un-pointed blank is struck by forming dies to create the desired shape, and in which a “slug” of scrap (i.e., undesirable excess material) is created and then discarded or recycled; or (iii) a rolling method, which involves passing a non-pointed blank through a set of roll forming dies to shape the point of the screw and remove any unwanted material. If the rolling method is used, the point may be rolled at the same time as the threads, or the threads and point may be rolled in separate processes.

Turning now to FIG. 7, this figure shows a schematic representation of one type of drive system 96 that includes a drive member 98 that is configured and arranged to be placed in operational contact with the drive arrangement 12 (FIG. 1) on the head region such that when the drive member 98 rotates, the fastening device 10 is rotated therewith at the same speed and in the same direction. In this embodiment of the drive system 96, a stabilizing frame 102 is also provided in order to stabilize the relevant components while the drive member 98 is rotated and downward force is applied thereto. For example, the drive member could be rotated at a predetermined speed of between 1000 rpm and 10,000 rpm, with a predetermined downward force applied thereto of between 300N and 4,500N. Of course other types of drive systems, both manual and powered, are also contemplated as being suitable for use with the current fastening device and method.

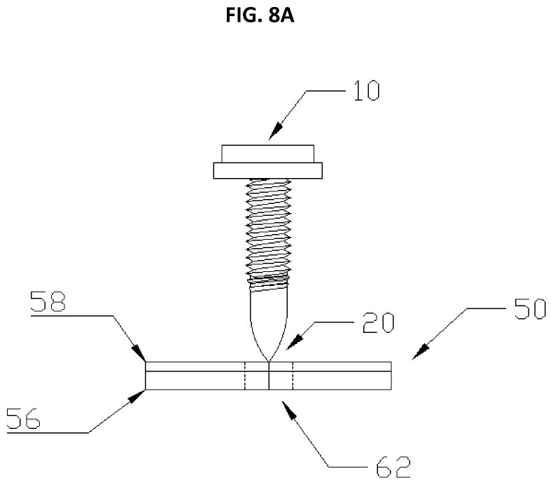

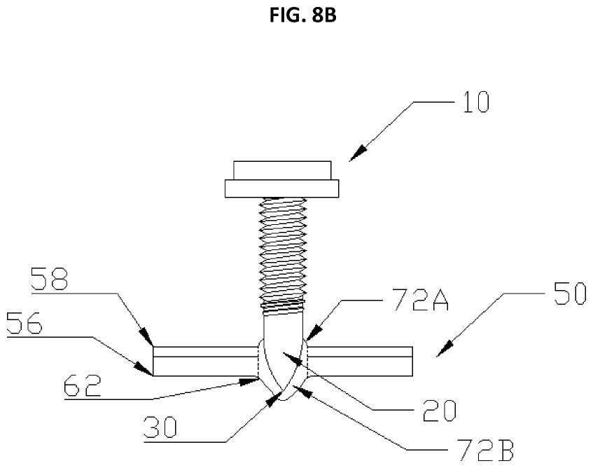

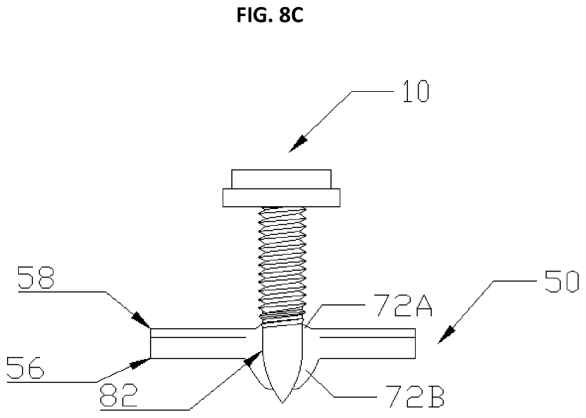

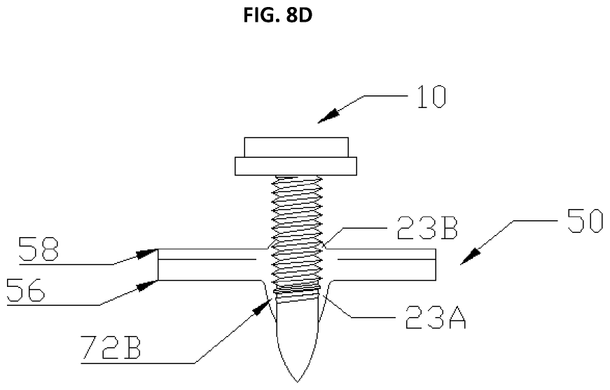

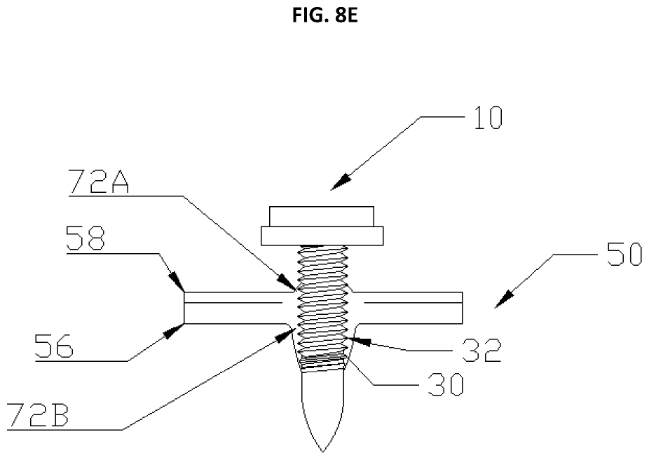

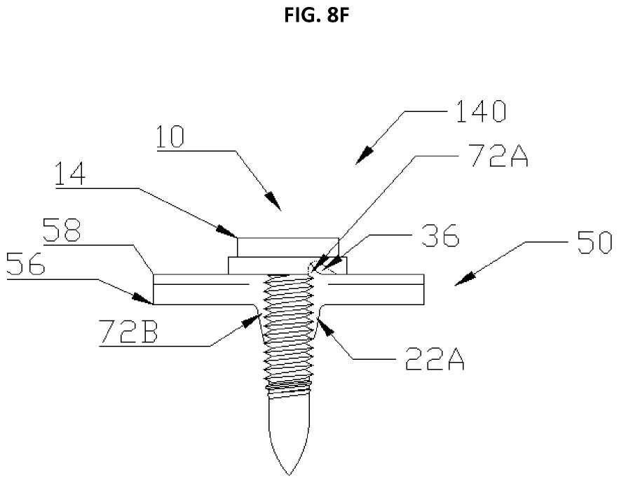

Turning now to FIGS. 8A-8F, one embodiment of a method for creating an assembly of two workpieces using the present fastening device, such as the present flow drill screw, is shown and will be described.

FIGS. 7 and 8A-8F all show a superposed, or layered, structure 50 consisting of a first workpiece 56 and a second workpiece 58, which is created by superposing (layering) the second workpiece 58 on the first workpiece 56 to create the superposed structure 50. The first and second workpieces 56 and 58 may each be of any suitable material (such as a sheet of aluminum, magnesium, steel, or other metal, plastic, carbon fiber reinforced plastic, carbon fiber, etc., where the first and second workpieces are of the same material or of different materials. Further, each of the workpieces may be of any suitable thickness, such as between 0.3 mm and 10.0 mm. Optionally, an adhesive may be provided between the first and second workpieces prior to inserting the fastening device therein. The first and second workpieces of the present invention could be used as components of a variety of different types of products, such as being provided as a component of a vehicle (such as an automobile, a truck, and SUV, farm equipment, construction equipment), as a component in a container, as a component in furniture, as a building material., etc. More specifically, when used in an automobile or truck, the finished assembly may be part of the vehicle's underbody, framing, body portions, or truck bed, etc. Further, although only the attachment of two workpieces is shown and described, the present method is also suitable for attaching three, four, or more workpieces (sheets) together to form an assembly.

The flow drill screw 10 of any of the embodiments discussed herein is provided, and as shown in FIG. 7, the screw is positioned such that a drive member 98 of the drive system 96 is in operational contact with a drive arrangement of the head portion 14 (FIG. 1) of the flow drill screw 10. As mentioned above, any suitable drive system can be used. Next, the drive member 98 of the drive system 96 is rotated while in operational contact with the drive arrangement of the flow drill screw 10, thereby rotating the flow drill screw.

It should be noted that although FIGS. 8A-8F omit the drive system and associated components for ease of description, the flow drill screw is still positioned in operational contact with the drive member in each of the stages depicted in FIGS. 8A-8F.

FIG. 8A is a depiction of the step of bringing the flow drill screw 10 into contact with a target area 62 (shows within dashed lines) of the superposed structure 50 while the flow drill screw 10 is being rotated by the drive member 98 (FIG. 7). It should be noted that one of the benefits of the present invention is that no pre-holes or other apertures are required in the target area of either of the workpieces 56 or 58. However, if desired, a pre-hole may be provided in the upper sheet, which in this case would be the second workpiece 58. Such a pre-hole may be advantageous where the upper sheet is thick, or where more than two layers are stacked upon each other, such as with a three-layer structure, in which the top layer includes a pre-hole, or a four-layer structure, in which the upper two or three layers each include a pre-hole. However, even if such a pre-hole is provided in any of the layers, such a pre-hole does not need to be threaded. FIG. 8A also shows the results of penetrating the target area 62 of the superposed structure 50 with the tip portion 20 of the rotating flow drill screw 10.

Turning now to FIG. 8B, as the flow drill screw 10 continues to be rotated by the drive member 98 (FIG. 7), the drive member moves downwardly in the longitudinal direction such that the point 30 of the tip portion 20 penetrates into the target area 62 of the superposed structure 50. As can be seen in FIG. 8B, the material adjacent the tip portion 20 softens from the heat generated by friction from the rotating flow drill screw, creating a flowed/extruded portion 72A/72B. More specifically, the combination of the selected rotation speed and the selected end load creates sufficient heat to soften the materials of the first and second workpieces 56, 58 to create the upper flowed/extruded portion 72A and the lower flowed/extruded portion 72B. Further, the shape of the tip portion 30, including any optional facets (or other structure), is configured such that with sufficient rotational speed and longitudinal pressure, the material of the workpieces 56, 58 is not chipped or cut, but is instead flowed/extruded. Such a result is beneficial because, among other things, it eliminates the debris and related clean-up associated with other self-tapping processes, and the extruded/flowed portion 72A/72B forms a hollow extrusion that adds strength to the joint by increasing the threaded axial length beyond the thickness of the superposed structure 50.

FIG. 8C shows how continued rotation of the rotating flow drill screw 10, along with continued longitudinal movement in the downward direction, results in the formation of a through-draft 82 in the superposed structure 50.

FIGS. 8D-8E show the progress of the method with further continued rotation of the rotating flow drill screw 10, along with continued longitudinal movement in the downward direction. Specifically, FIG. 8D shows the thread forming step wherein a thread forming zone 23A of the fastener 10 passes into the through draft 82, which is still at least partially softened, to create the threads, followed by a usable thread zone 23B of the fastener.

FIG. 8E depicts the stage of the process in which the threads of the threaded portion 16 are engaged with both the upper flowed/extruded portion 72A and the lower flowed/extruded portion 72B.

Finally, FIG. 8F shows how the continued rotation and downward movement results in the tightening of the flow drill screw 10, thereby forming an assembly 140. It should be noted that FIG. 8F depicts the screw head portion 14 in partial cutaway to show how an optional undercut portion 136 in the base of the head portion provides the necessary space for the upper flowed/extruded portion 72A, thereby enabling the screw head portion 14 to be in contact with the upper surface of the second workpiece 58.

As can be understood from a review of the above-description and FIGS. 7 and 8A-8F, the steps of bringing the flow drill screw 10 into contact with the target area 62 (FIG. 8A), penetrating the target area 62 (FIG. 8B), forming the through-draft 82 (FIG. 8C), forming the first and second threads in the through-draft 82 (FIG. 8D), engaging the threads (FIG. 8E), and tightening of the flow drill screw 10 to thereby form the assembly 140 (FIG. 8F) are all fully performed via access from a side of the superposed structure 50 associated with the second workpiece 58 (i.e., the upper side), without a need for access to an opposite side of the superposed structure associated with the first workpiece 56 (i.e., the lower side).

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims. Further, it should be noted that features from one embodiment can be incorporated into other embodiments.

Various features of the invention are set forth in the appended claims.

What is claimed is:

1. A thread forming flow drilling fastener comprising:
a threaded region that defines a major diameter of a largest thread and a minor diameter of the largest thread; and
a tip region including a flow drilling tip, wherein the tip region defines a tip diameter,
wherein the tip diameter is greater than the minor diameter and is less than or equal to the major diameter of the largest thread on the fastener.

2. The thread forming flow drilling fastener according to claim 1, wherein the tip diameter is greater than or equal to 1.02 times the minor diameter and is less than or equal to the major diameter of the largest thread on the fastener.

3. The thread forming flow drilling fastener according to claim 1, wherein the tip diameter is greater than or equal to 1.1 times the minor diameter and is less than or equal to the major diameter of the largest thread on the fastener.

4. The thread forming flow drilling fastener according to claim 1, wherein the tip diameter is greater than or equal to 1.2 times the minor diameter and is less than or equal to the major diameter of the largest thread on the fastener.

5. The thread forming flow drilling fastener according to claim 1, wherein the tip diameter is greater than or equal to 1.25 times the minor diameter and is less than or equal to the major diameter of the largest thread on the fastener.

6. The thread forming flow drilling fastener according to claim 1, wherein a cross-section of an outer distal end of the tip region is rounded.

7. The thread forming flow drilling fastener according to claim 1, wherein a cross-section of an outer distal end of the tip region is polygonal.

8. The thread forming flow drilling fastener according to claim 1, wherein the threaded region includes a tapered threaded region that includes sharp tapered lead threads near the tip region.

9. The thread forming flow drilling fastener according to claim 1, wherein the threaded region includes a tapered threaded region that includes open crested tapered lead threads near the tip region.

10. The thread forming flow drilling fastener according to claim 1, wherein the threaded region includes threads of a uniform major diameter.

11. The thread forming flow drilling fastener according to claim 1, further comprising a non-threaded and non-tapered region between the threaded region and the tip region.

12. A combined thread forming and flow drilling fastener comprising:
a threaded region including a helical thread that defines a major diameter defined as the largest diameter of the helical thread and a minor diameter defined as the smallest diameter of the helical thread of the threaded region; and
a flow drilling tip region adjacent to the threaded region, wherein the tip region defines a tip diameter as the largest diameter of the tip region,
wherein the tip diameter is greater than the minor diameter and is less than or equal to the major diameter of the threaded region.

13. The thread forming and flow drilling fastener according to claim 12, wherein the cross-section of the threaded region is rounded.

14. The thread forming and flow drilling fastener according to claim 12, wherein the cross-section of the threaded region is polygonal.

15. The thread forming and flow drilling fastener according to claim 12, wherein a terminating tip of the fastener is sharp.

16. The thread forming and flow drilling fastener according to claim 12, wherein a terminating tip of the fastener is rounded.

17. The thread forming and flow drilling fastener according to claim 12, wherein the flow drilling tip of the fastener is symmetrical.

18. The thread forming and flow drilling fastener according to claim 12, wherein the flow drilling tip of the fastener is asymmetrical.

19. The thread forming and flow drilling fastener according to claim 12, further comprising a head region with a drive arrangement on a first side thereof, wherein a second side of the head region includes an undercut region sized to capture an up-flow of material during flow drilling related to the thickness of substrate to be fastened such that the head of the fastener sits flush upon final tightening.
